(19) United States
(12) Patent Application Publication
(10) Pub. No.: US 2010/0014131 A1
(43) Pub. Date: Jan. 21, 2010

(54) IMAGE PROCESSING APPARATUS AND METHOD

(75) Inventor: Min-ki CHO, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/388,601

(22) Filed: Feb. 19, 2009

(30) Foreign Application Priority Data
Jul. 18, 2008 (KR) 2008-70070

(51) Int. Cl. H04N 1/46

(52) U.S. Cl. 358/504; 358/505

(57) ABSTRACT

An image processing method and an image processing apparatus to calibrate a scan image include selecting any one of a plurality of colors having different gray reproduction characteristics, and calibrating the scan image based on a color table corresponding to the selected color among a plurality of color tables.

### CROSS-REFERENCE TO RELATED APPLICATIONS

This application claims priority from Korean Patent Application No. 10-2008-0070070, filed on Jul. 18, 2008 in the Korean Intellectual Property Office, the disclosure of which is incorporated herein by reference.

### BACKGROUND OF THE INVENTION

1. Field of the Invention

The present general inventive concept relates to an image processing apparatus and an image processing method to calibrate a scan image according to a user preference.

2. Description of the Related Art

In general, an RGB scan image inputted through a scanner, a digital camera or the like undergoes color calibration for color-converting to be suitable for characteristics of an output device.

For example, an image processing apparatus, such as a computer, can perform color calibration based on a color table or a look-up table (LUT) which is generated based on CIELab data obtained by color-measuring a standard chart for color calibration, with respect to a scan image having RGB data.

Such an image processing apparatus typically stores a single color table and performs color calibration based on the stored single color table for every input scan image.

Thus, a calibrated scan image always provides the same color reproduction characteristic irrespective of a user preference. In particular, even in the case of gray reproduction, only the same color reproduction characteristic is provided, which cannot satisfy various user preferences.

### SUMMARY

The present general inventive concept provides an image processing apparatus and an image processing method to provide a plurality of color reproduction characteristics for a scan image and to select a user preference color reproduction characteristic.

Additional aspects of the present general inventive concept will be set forth in part in the description which follows and, in part, will be obvious from the description, or may be learned by practice of the present general inventive concept.

The foregoing and/or other aspects and utilities of the present general inventive concept can be achieved by providing an image processing method of calibrating a scan image, the method including selecting any one of a plurality of colors having different gray reproduction characteristics, and calibrating the scan image based on a color table corresponding to the selected color among a plurality of color tables.

The selecting of the one of the plurality of colors may include displaying a UI to select any one of the plurality of colors.

The displayed UI may include a plurality selection items including a basic color and at least one preference color.

The preference color may include at least one of reddish, greenish and bluish.

The plurality of color tables may be obtained by applying a predetermined offset to preset color data.

The offset may vary according to brightness of the color data.

The offset may vary according to chroma (chrominance component) of the color data.

The method may further include displaying the calibrated scan image.

The foregoing and/or other aspects and utilities of the present general inventive concept can be also achieved by providing an image forming apparatus to perform printing for the scan image calibrated by the image processing method as described above.

The foregoing and/or other aspects and utilities of the present general inventive concept can also be achieved by providing an image processing apparatus including: an image processing part to calibrate a scan image, a user selection part through which any one of a plurality of colors having different gray reproduction characteristics is selected, and a controller to control the image processing part to calibrate the scan image based on a color table corresponding to the selected color among a plurality of color tables.

The user selection part may include a displayable UI to select any one of the plurality of colors.

The UI may include a plurality of selection items including a basic color and at least one preference color.

The preference color may include at least one of reddish, greenish and bluish.

The plurality of color tables may be obtained by applying a predetermined offset to preset color data.

The offset may vary according to brightness of the color data.

The offset may vary according to chroma (chrominance component of a video signal) of the color data.

The apparatus may further include a display part to display the calibrated scan image. The foregoing and/or other aspects and utilities of the present general inventive concept can also be achieved by providing a computer-readable medium to contain computer-readable codes as a program to perform a method of an image processing apparatus to form a calibrated image, the method including selecting one of a plurality of colors having different gray reproduction characteristics, and calibrating the scan image based on a color table corresponding to the selected color among a plurality of color tables.

The foregoing and/or other aspects and utilities of the present general inventive concept can also be achieved by providing an image processing apparatus including a user selection part to select one of a plurality of colors having different gray reproduction characteristics, and an image processing part to calibrate a scanned image to generate a calibrated image according to one of color tables corresponding to the selected color.

The apparatus may further include a display part, and the user selection part may include a user interface to be displayed on a screen of the display part, and the user interface includes the plurality of colors.

The apparatus may further include an image forming device to print the calibrated image.

The apparatus may further include a housing, and the user selection part and the image processing part may be disposed in the housing.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 and FIG. 2 are block diagrams illustrating an image processing apparatus according to an exemplary embodiment of the present general inventive concept;

FIG. 3 is a diagram for illustrating calibration for an RGB scan image according to an exemplary embodiment of the present general inventive concept;

FIG. 4 illustrates a user interface according to an exemplary embodiment of the present general inventive concept;

FIGS. 5-7 illustrate offsets set in a plurality of color tables;

FIG. 8 illustrates an example of a scan image calibrated by a plurality of color tables; and

FIG. 9 is a flowchart illustrating an image processing method according to an exemplary embodiment of the present general inventive concept.

### DETAILED DESCRIPTION OF EMBODIMENTS

Reference will now be made in detail to the embodiments of the present general inventive concept, examples of which are illustrated in the accompanying drawings, wherein like reference numerals refer to like elements throughout. The exemplary embodiments are described below so as to explain the present general inventive concept by referring to the figures.

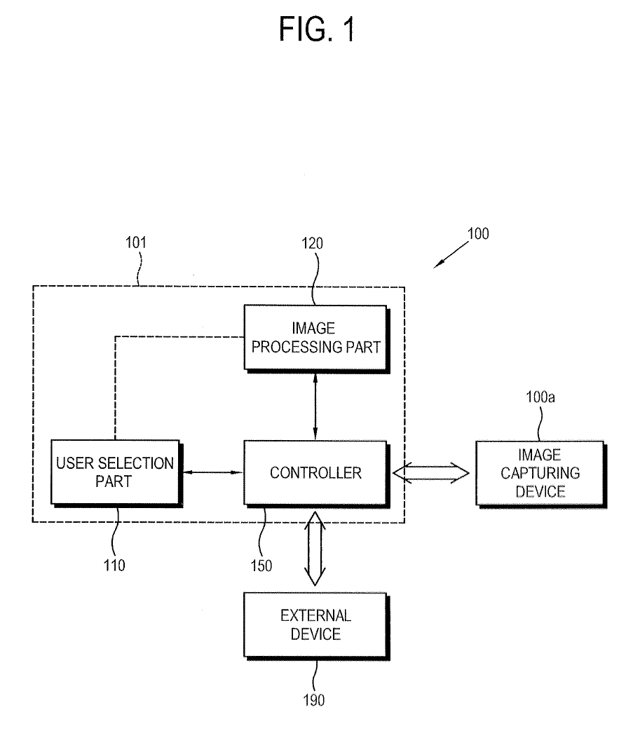

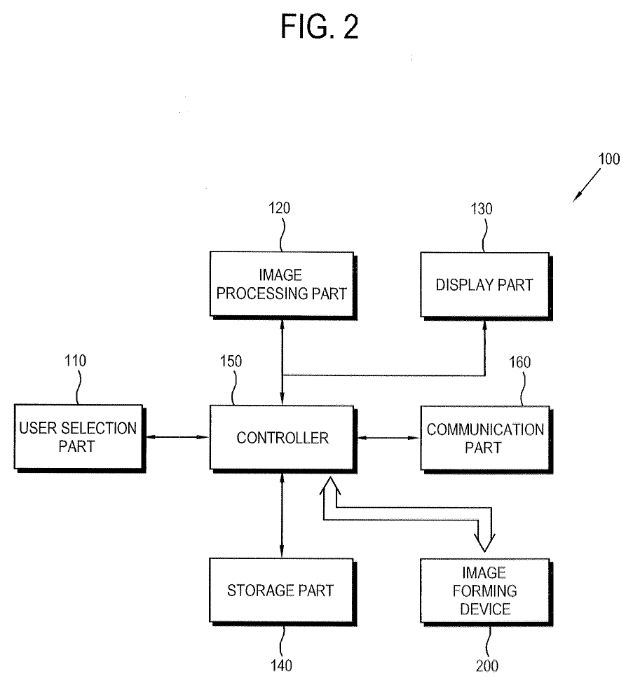

FIGS. 1 and 2 are block diagrams illustrating an image processing apparatus 100 according to an exemplary embodiment of the present general inventive concept.

The image processing apparatus 100 is embodied as a host apparatus such as a computer, receives an RGB scan image from an image capturing device 100a, such as a scanner, a digital camera or the like, and performs color calibration for color-converting to be suitable for an output characteristic. In this respect, the image processing apparatus 100 may perform color calibration by execution of an application program such as a scanner driver, Photoshop or the like.

The image capturing device 100a may be connected to the controller 150 through a wired or wireless communication line to receive a signal representing an image, such as the RGB scan image, from the image capturing device 100a. It is possible that the image capturing device 100a may be mounted to a housing 101 of the image processing apparatus 100. The image capturing device 100a may include a scanning or photographing unit to scan a document or photograph an object, to capture the image from the document or the object, and to generate the signal representing the captured image as the scanned or photographed image.

Alternatively, the image processing apparatus 100 may be realized as a scanner, printer, copier, facsimile, multiplexer or the like to perform color calibration, that is, color conversion for a scan image.

When the image processing apparatus 100 is realized as an image forming apparatus such as the printer, copier, facsimile, multiplexer or the like, the image forming apparatus may further include an image forming device 200 as illustrated in FIG. 2. The image forming device may have a feeding unit to feed a printing medium, a printing unit to form a print image on the printing medium according to a color calibrated image received from the controller 150.

The calibrated scan image may be made of data corresponding to CIEXYZ, CIELab, CIELuv, CMYK, etc., according to a color space provided by the image processing apparatus 100.

As illustrated in FIG. 1, the image processing apparatus 100 includes a user selection part 110, an image processing part 120 and a controller 150 which are disposed in a housing 101 thereof. As shown in FIG. 2, the image processing apparatus 100 may further include a display part 130, a storage part 140 and a communication part 160 which are disposed in the housing 101 thereof. It is possible that the display part 130 may be connected to the controller 150 through a wired or wireless communication line.

The user selection part 110 generates a signal to display a user interface window to allow a user to select any one of a plurality of colors for color reproduction characteristics through the user interface window. If a user selects any one of the plurality of colors for color reproduction characteristics to calibrate a scan image, the controller 160 receives a signal through the user interface window, controls the image processing part 120 to calibrate the scan image based on a color table corresponding to the selected color among a plurality of color tables stored in the storage part 140 using the signal, and generates a signal representing the calibrated scan image.

The user selection part 110 may be embodied as function key buttons for an image forming apparatus, a mouse for a host apparatus, a keyboard or the like. In the case that the image processing apparatus 100 is embodied as an image forming apparatus, the image forming apparatus may be provided with additional function keys to select a color reproduction characteristic. The user selection part 110 may include a user interface (UI) generated by execution of a printer driver and displayable on the display part 130.

The user interface (UI) may be used to generate the user interface window displayed on a screen of the display part 130. When the color items are displayed in the user interface window in a screen of a display part, a user can select one of the color items by disposing a cursor on the corresponding color and clicking the cursor. The user interface (UI) may be a touch screen formed on the screen of the display part such that a user can select the color by touching or pressing a corresponding area indicating the color. A signal representing the selected color can be transmitted to the controller 150 through either the user selection part 110 or the display part.

The image processing part 120 performs color calibration to convert a scan image to correspond to a given color space based on a color table corresponding to color selected through the user selection part 110. The color space may be aided by the image processing apparatus 100, and is exemplified to convert a scan image of RGB data into CIELab (or Lab) data as the calibrated scan image signal according to the present embodiment.

A communication part 160 is connected to the controller 150 to communicate with an external device 190 to or the image forming device 200 to transmit the calibrated scan image signal to the external device 190 to or the image forming device 200. The image capturing device 100a may be connectable to the controller 150 through the communication part 160. It is also possible that the image forming device 200 may be directly connected to the controller 150.

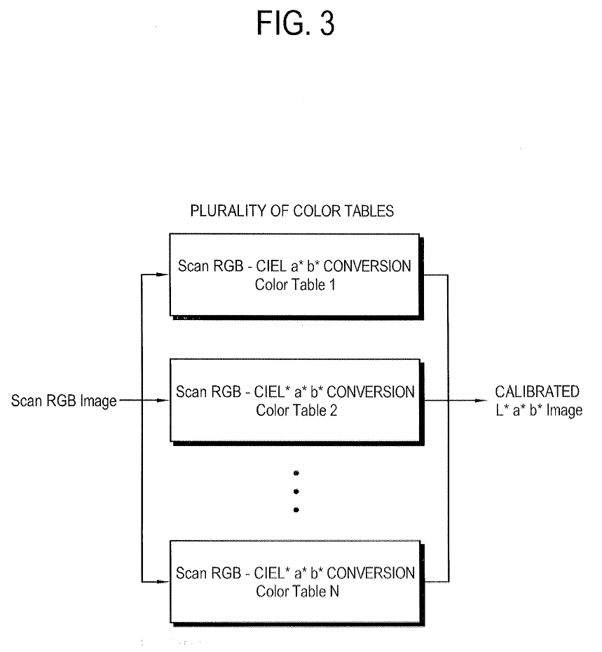

FIG. 3 is a diagram illustrating calibration for an RGB scan image according to an exemplary embodiment of the present general inventive concept.

As illustrated in FIGS. 1-3, the image processing part 120 performs color calibration to convert an RGB scan image into a Lab image based on any one of the plurality of color tables stored in the storage part 140.

The display part 130 displays the RGB scan image and the calibrated Lab image to a user. In this respect, the display part 130 may display a UI such that any one of a plurality of colors for color reproduction characteristics can be selected through the UI.

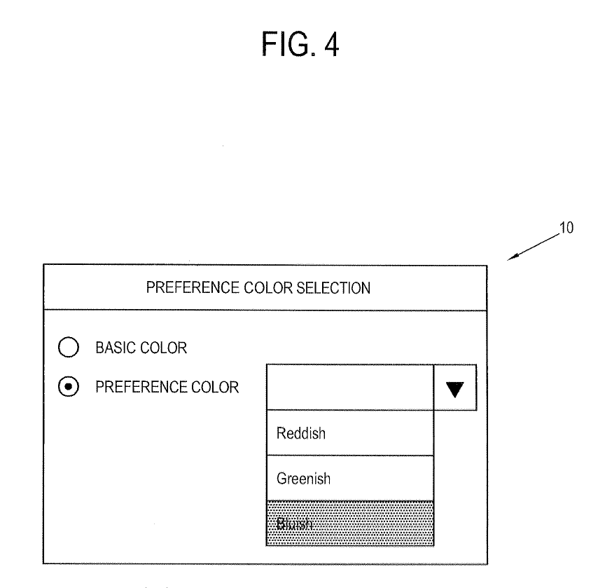

FIG. 4 illustrates a UI 10 displayed according to an exemplary embodiment of the present general inventive concept.

As illustrated in FIG. 4, the UI 10 displayed to a user includes a plurality of selection items including a basic color and at least one preference color. In this respect, the preference color may include at least one of reddish, greenish and bluish.

The UI 10 may be generated from the user selection part according to a control of the controller 150. The UI may be displayed on the display part 130 as the user interface window.

The storage part 140 is embodied as an HDD, a semiconductor chip such as RAM, or the like. In the storage part 140 is stored the plurality of color tables or look-up tables (LUT) for color calibration.

As illustrated in FIGS. 3 and 4, the scan RGB-CIEL a*b*CONVERSION Color tables 1, 2, . . . , and N can be stored in the storage part 140. When one of the scan RGB-CIEL a*b*CONVERSION Color tables 1, 2, . . . , and N is selected, the scan image can be calibrated to the calibrated scan image according to the selected RGB-CIEL a*b*CONVERSION Color tables 1, 2, . . . , or N.

When one of the preference color is selected through the UI 10, it is possible that one of the scan RGB-CIEL a*b*CONVERSION Color tables 1, 2, . . . , and N is selected according to the preference color 9 selected from the UI of FIG. 4

According to the present embodiment, the plurality of color tables may be generated on the basis of CIELab data obtained by color-measuring a standard chart for color calibration. The standard chart is a reference chart including references useable for the color calibration.

More specifically, the image processing apparatus 100 obtains scan RGB data for every patch in the standard chart by scanning the standard chart for color calibration, and then, obtains CIELab data for every patch in the standard chart by color-measuring the standard chart for scanner calibration using a color-measuring device. Then, the image processing apparatus 100 performs modeling for scanner color reproduction characteristics on the basis of the CIELab data corresponding to the scan RGB data. The patch represents a unit area of the scanned image, and the scan image may include a plurality of unit areas. Accordingly, the scanned image can be converted in a unit of the unit area.

Then, the image processing apparatus 100 calculates output CIELab data using the modeling result for any one RGB data among input lattice points of a size of N*N*N. The image processing apparatus 100 calculates such CIELab data for the whole input lattice points having a size of N*N*N to generate color tables for color calibration, and stores the color tables. N is a natural number. It is possible that N is the number of pixel included in an area of the scanned image.

In this respect, the image processing apparatus 100 may generate a plurality of color tables having gray reproduction characteristics based on new color data obtained by applying a predetermined offset to color data (for example, Lab data) of the generated color tables. The Lap data may be one of standard color data formats. At least one of predetermined offsets can be applied to the corresponding color data to form the plurality of color tables.

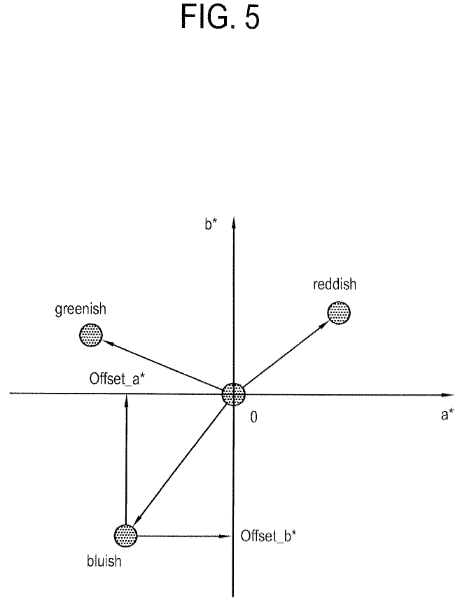

FIGS. 5-7 are diagrams illustrating offsets set in a plurality of color tables.

As illustrated in FIG. 5, the image processing apparatus 100 generates a plurality of new color tables by respectively applying different offsets to the previously stored color tables, and stores the generated new color tables in the storage part 140.

In this respect, the plurality of new color tables may be generated by applying predetermined offsets to achromatic or gray data among preset Lab data.

More specifically, the image processing apparatus 100 calculates chroma (C=\sqrt{a²+b²}) for every color data modeled for the input lattice points through the preset Lab data, and may determine the corresponding color data to be an achromatic color if the calculated chroma is not higher than a predetermined threshold (for example, 0).

Then, the image processing apparatus 100 generates new Lab color data by applying predetermined offsets to the gray Lab data according to the determination result. Accordingly, the generated Lab data has gray reproduction characteristics different from the preset Lab data.

Referring to FIG. 5, if color tables corresponding to reddish, greenish and bluish are generated, the image processing apparatus 100 generates new color data by applying offsets corresponding to respective color tables to the preset color data, as represented by the following equation 1:

new_{—}a*=a*+offset_{—}a*

new_{—}b*=b*+offset_{—}b*

Here, referring to FIG. 1, in the case of bluish, offset_a* may be −2, and offset_b* may be −2.

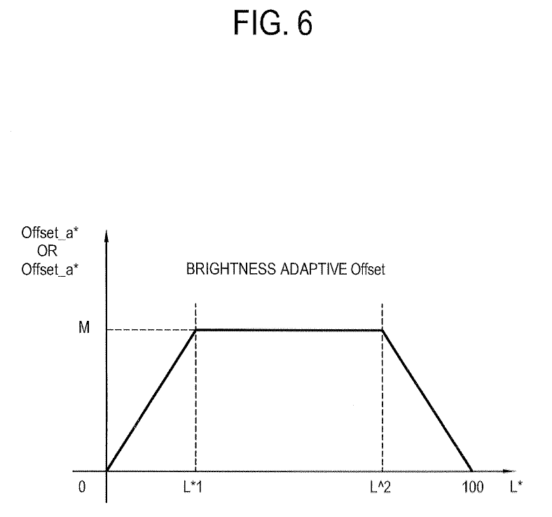

Referring to FIG. 6, offsets applied to the respective color tables may be varied according brightness of color data, as represented by the following equation 2:

$${offset\_a}^{*} = \{ \begin{matrix}M / {L}_{1}^{*} \times input\_L , & if input\_L \leq {L}_{1}^{*} \\ M , & if {L}_{1}^{*} < input\_L \leq {L}_{2}^{*} \\ M / ( 100 - {L}_{2}^{*} ) \times input\_L , & input\_L > {L}_{2}^{*}\end{matrix} \\ {offset\_b}^{*} = \{ \begin{matrix}M / {L}_{1}^{*} \times input\_L , & if input\_L \leq {L}_{1}^{*} \\ M , & if {L}_{1}^{*} < input\_L \leq {L}_{2}^{*} \\ M / ( 100 - {L}_{2}^{*} ) \times input\_L , & input\_L > {L}_{2}^{*}\end{matrix}$$

For example, in the case of a brightness-adaptive offset, the offset is constant within a predetermined brightness range (between L*1 and L*2), but linearly increases or decreases beyond the range.

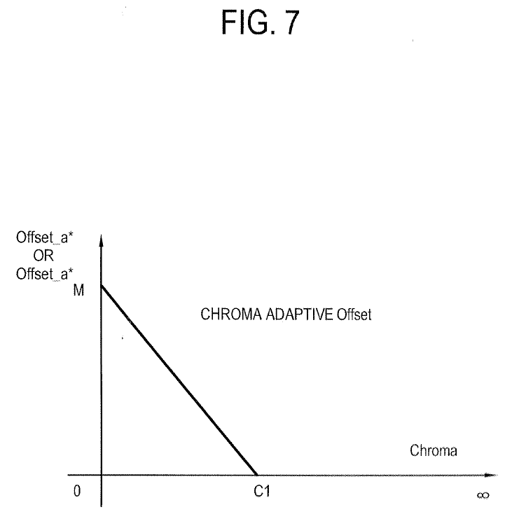

Referring to FIG. 7, offsets applied to the respective color tables may be varied according to chroma of color data, as represented by the following equation 3:

$${offset\_a}^{*} = \{ \begin{matrix}M / {C}_{1}^{*} \times input\_C , & if input\_C < {C}_{1}^{*} \\ 0 , & else\end{matrix} \\ {offset\_b}^{*} = \{ \begin{matrix}M / {C}_{1}^{*} \times input\_C , & if input\_C < {C}_{1}^{*} \\ 0 , & else\end{matrix}$$

As described above, according to the present embodiment, four color tables including one basic color and three preference colors for gray reproduction each corresponding to reddish, greenish and bluish are generated and stored, as illustrated in FIGS. 4 and 5 by way of example. However, the number of the color tables is not limited thereto. Further, offsets may be varied according to other factors in addition to the brightness and chroma. Furthermore, offsets may be applied to chromatic colors to generate new color tables, in addition to achromatic colors.

The storage part 140 may further store a scan image and an image calibrated by any one of a plurality of color tables. For example, the storage part 140 may store an RGB scan image and a calibrated scan image, that is, a Lab image.

The communication part 150 receives a scan image from a scanner, a digital camera or the like, or transmits a calibrated scan image to an image forming apparatus, an outside server or the like. The communication part 150 may be embodied as a wired or wireless communication module for communication with an external device, a USB port or the like.

The controller 160 controls overall operations of the image processing apparatus 100. More specifically, the controller 160 controls the image processing part 120 to calibrate an input scan image based on a color table corresponding to a color selected through the user selection part 110 among a plurality of color tables having different gray reproduction characteristics.

The controller 160 may generate a UI for user selection as shown in FIG. 4 and display the UI through the display part 130, for an RGB scan image inputted from outside through a scanner, digital camera, USB memory or the like. If a user selects any one of the plurality of colors for gray reproduction through the user selection part 110, the controller 160 may control to calibrate a scan image based on any one of the color tables stored in the storage part 140 and to display the calibrated scan image on the display part 140.

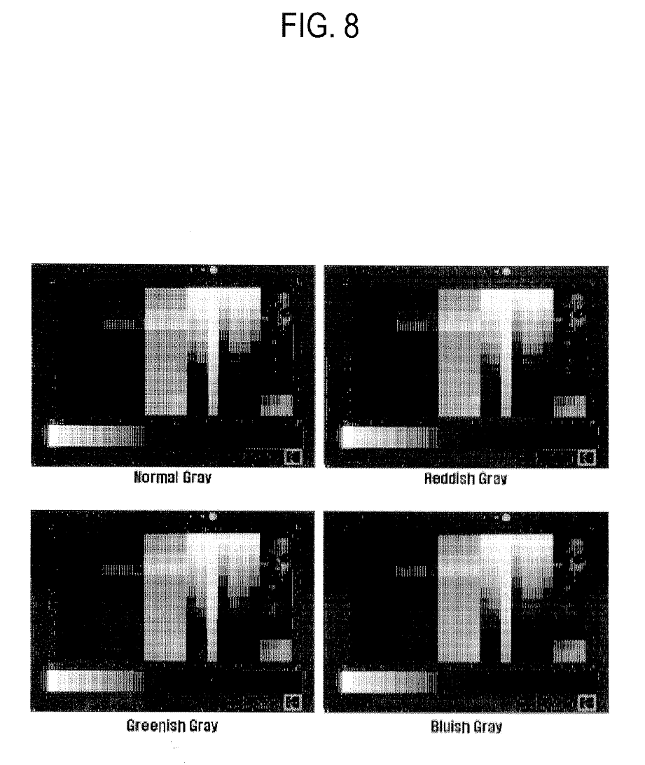

FIG. 8 illustrates an example of a scan image calibrated by a plurality of color tables.

As illustrated in FIG. 8, if a scan image is calibrated for one basic color and three preference colors of reddish, greenish and bluish, a plurality of images having different color reproduction characteristics is generated. In particularly, in the case of achromatic colors, the calibrated scan image has different color reproduction characteristics.

Hence, the image processing apparatus 100 according to the present general inventive concept can realize various color reproduction characteristics according to a user preference.

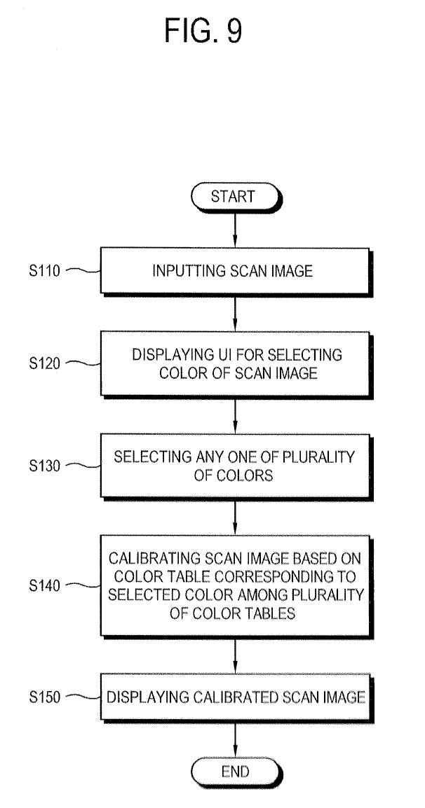

Hereinafter, an image processing method in the image processing apparatus 100 will be described with reference to FIG. 9.

First, the image processing apparatus 100 may receive an RGB scan image from a scanner, digital camera or the like in operation S110.

Then, the controller 160 displays a UI for selecting a color for gray reproduction for the scan image in operation S120. In this respect, the displayed UI may include a plurality of selection items including a basic color and at least one preference color. The preference color may include at least one of reddish, greenish and bluish.

Then, a user may select any one of the plurality of colors through the displayed UI (S130).

Then, the controller 160 calibrates the scan image based on a color table corresponding to the color selected in operation S130 among a plurality of color tables stored in the storage part 140. In this respect, the plurality of color tables are obtained by applying predetermined offsets to preset color data. The offsets may be varied by one of the brightness and chroma of the color data.

The calibrated scan image calibrated in operation S140 is displayed through the display part 130 in operation S150.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, an image processing apparatus and an image processing method according to the present general inventive concept can provide a plurality of color reproduction characteristics for a scan image and can select user preferred color reproduction characteristics.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image processing method of calibrating a scan image, the method comprising:
selecting one of a plurality of colors having different gray reproduction characteristics; and
calibrating the scan image based on a color table corresponding to the selected color among a plurality of color tables.

2. The method of claim 1, wherein the selecting of the color comprises displaying a user interface to select the one of the plurality of colors.

3. The method of claim 2, wherein the displayed user interface comprises a plurality selection items comprising a basic color and at least one preference color.

4. The method of claim 3, wherein the preference color comprises at least one of reddish, greenish and bluish.

5. The method of claim 1, wherein the plurality of color tables is obtained by applying a predetermined offset to preset color data.

6. The method of claim 5, wherein the offset varies according to brightness of the color data.

7. The method of claim 5, wherein the offset varies according to chroma of the color data.

8. The method of claim 1, further comprising:
displaying the calibrated scan image.

9. An image forming apparatus to perform printing an image calibrated by the image processing method according to claim 1.

10. An image processing apparatus comprising:
an image processing part to calibrate a scan image;
a user selection part through which any one of a plurality of colors having different gray reproduction characteristics is selected; and
a controller to control the image processing part to calibrate the scan image based on a color table corresponding to the selected color among a plurality of color tables.

11. The apparatus of claim 10, wherein the user selection part comprises a displayable UI for selecting any one of the plurality of colors.

12. The apparatus of claim 11, wherein the UI comprises a plurality of selection items comprising a basic color and at least one preference color.

13. The apparatus of claim 12, wherein the preference color comprises at least one of reddish, greenish and bluish.

14. The apparatus of claim 10, wherein the plurality of color tables is obtained by applying a predetermined offset to preset color data.

15. The apparatus of claim 14, wherein the offset varies according to brightness of the color data.

16. The apparatus of claim 14, wherein the offset varies according to chroma of the color data.

17. The apparatus of claim 10, further comprising:
a display part to display the calibrated scan image.

18. An image processing apparatus comprising:
a user selection part to select one of a plurality of colors having different gray reproduction characteristics; and
an image processing part to calibrate a scanned image to generate a calibrated image according to one of color tables corresponding to the selected color.

19. The apparatus of claim 18, further comprising:
a display part,
wherein the user selection part further comprises a user interface to be displayed on a screen of the display part, and the user interface includes the plurality of colors.

20. The apparatus of claim 18, further comprising:
an image forming device to print the calibrated image.

21. The apparatus of claim 18, further comprising:
a housing,
wherein the user selection part and the image processing part are disposed in the housing.
